(19) United States
(12) Patent Application Publication
(10) Pub. No.: US 2004/0220788 A1
(43) Pub. Date: Nov. 4, 2004

(54) Method for representing a volume of earth using modelling environment

(76) Inventors: Steven Brent Assa, Cambridge (GB); David Mack Endres, Oslo (NO)

Correspondence Address: SCHLUMBERGER-DOLL RESEARCH, 36 OLD QUARRY ROAD, RIDGEFIELD, CT, 06877-4108, US

(21) Appl. No.: 10/478,730

(22) PCT Filed: May 8, 2002
(86) PCT No.: PCT/GB02/02135

(30) Foreign Application Priority Data
Jun. 8, 2001 (GB) 01139882.3

(51) Int. Cl. G06G 7/48

(52) U.S. Cl. 703/10

(57) ABSTRACT

The invention concerns a method for representing a volume of earth using a modelling environment comprising an application, said environment being implemented in one or a plurality of programmed computers. The invention is characterised in that the method comprises the following step: selecting said volume of earth; inserting faults into said volume of earth in order to define at least one fault block; inserting horizons and/or unconformities into said fault block in order to create at least a block unit; and archiving said created block unit.

### FIELD OF THE INVENTION

The present invention relates to a method for representing a volume of earth using a modelling environment.

### PRIOR ART

Geologists, geophysicists and petroleum engineers use geological structures and properties models to plan exploration and production of hydrocarbons and, to a lesser extent, other mineral rocks and fluids. As hydrocarbons become more and more scarce, the accuracy of the computerised models becomes increasingly important to limiting the cost of locating and producing hydrocarbons.

Practically, computerised models are three-dimensional representations of volumes of earth, which take into account the geometrical structure of the materials constituting said volumes, as well as the properties of said materials, such as the porosity. Those computerised models are called geometry models.

The invention relates notably to a modelling environment commercialised by the company group Schlumberger™ under the appellation GeoFrame Modelling Office. The GeoFrame Modelling Office is an integrated suite of software that permits the modelling of volumes of earth. It comprises a Common Model Builder (CMB), which shows a three-level hierarchy. The bottom level comprises an Application Data Interface (ADI) and a Geometry Query Interface (GQI) associated with a solid modeller, the middle level comprises an Interactive Geometric Modeller (IGM) and the top level comprises CMB applications such as the property modelling application Property 3D. The ADI provides a programmatic interface to a shareable database comprising bulk data corresponding to the volumes of earth to be modelled.

The bottom level of the CMB allows access to the shareable database and permits, on one hand, the construction of a geometric representation of a set of framework surfaces taken from differential geometry and combinatorial topology and, on the other hand, the three-dimensional visualisation of the geometric representation of said framework. In particular, the ADI manages the bulk data samples used to define the model. The solid modeller is provided by a corporation named XOX and is called SHAPES™. It is mainly a computational library for low dimensional combinatorial topology and differential geometry which takes a volume of earth which is of interest (Volume Of Interest or VOI) as an empty box and represents surfaces of said VOI as connected sets of triangles without integrating any notion relating to geology or geophysics. The GQI generates and manipulates material property fields, hides data structure mismatches that may exist, aggregates sets of the solid modeller primitive procedures into more readily usable services and implements the fundamental notion of a reservoir feature. It relies on the ADI for bulk data services relating to the property fields that a CMB application manipulates.

The middle level provides high interactive geometrical model building, editing and rendering methods. These services depend on the bottom level for their geometrical and topological content. However, communication with the bottom level is one way and the bottom level is not aware of the geological semantic that is generally attached to the instances manipulated in the middle or in the top levels.

Geoscience and geometry based applications form the top level. Those applications allow a user to create and update a three-dimensional representation of a VOI. To that effect, they invoke the GQI to assemble framework components into a topologically valid representation of the VOI and to attach various geologic fields to framework entities, thereby adding a geological semantic on top of the geometrical representation provided by the bottom level. This is the case of the application Property 3D, which is the name of the modelling office application that assemble a framework and applies various geo-statistical techniques to populate said framework with three-dimensional property fields.

According to the state of the art, the Property 3D application implements, in the CMB, a framework assembly according to the three main following steps.

In the first step a VOI is selected by the user of the application.

In the second step, fault blocks are generated and sorted. Practically, for each fault inserted in the VOI, Property 3D extrapolates said fault so that it splits said VOI in VOI sub-volumes and insert the extended fault into the VOI, thus defining a plurality of fault blocks.

In the third step, the vertical fault framework obtained following achievement of the second step is complemented with a horizontal framework of horizons and unconformities, including onlapping unconformities. The unconformities are depositional or erosional surfaces appearing, notably, when a particular zone of the VOI has been submitted to deposition or erosion. Unconformities and horizons are sorted in increasing age and, for each unconformity in the ordered set obtained, the following is done:—for each unconformity whose age is bracketed by a fault block, it is checked if said unconformity non-trivially intersects said fault block. In the affirmative, the unconformity is extrapolated so that it splits said fault block and inserted into the fault block; and—for each horizon that is younger than the last inserted unconformity, but is older than the next unconformity, the horizon is extrapolated so that it splits any fault block that it intersects and is inserted into the fault block. Practically, onlapping unconformities are inserted after other unconformities.

In the assembly obtained, the horizontal framework defines reservoir units and, together, the horizontal and vertical frameworks decompose said reservoir units into block units.

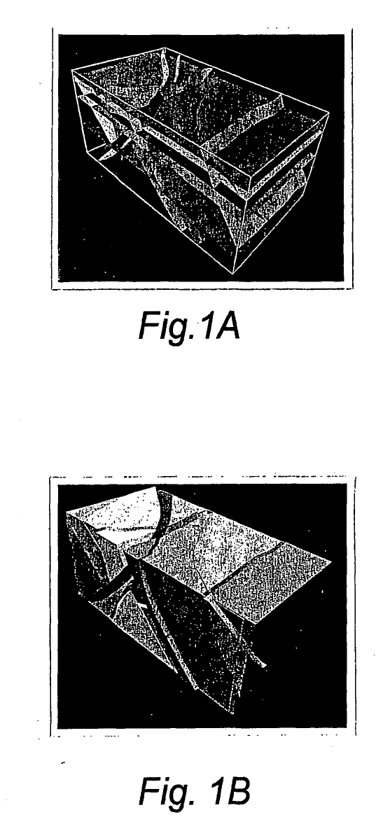

After framework assembly, Property 3D processes said block units with a view to construct property fields in each of them and represents the VOI. FIGS. 1A and 1B illustrate a framework assembly represented by Property 3D. The FIG. 1A is a representation of a raw structural framework before processing by Property 3D and the FIG. 1B is an exploded view of a block unit after framework assembly using Property 3D.

Memory addresses are coded, in the Property 3D application, as well as in the computer hardware implementing said application, into a 32-bit space. The theoretical maximum number of addresses that may exist in a memory of a computer configured to manage 32-bit addresses, that is to say the 32-bit virtual memory of said computer, is equal to 2³² or, approximately, 4.294×10⁹. However, the number of addresses that are effectively allowed to a user of such a computer, that is to say the user partition, is in fact about half the 32-bit virtual memory. Thus, 32-bit computers are physically not able to manage a number of data which is greater than the above-defined user partition of the 32-bit virtual memory space: there is an exhaustion of the 32-bit virtual memory. In fact, the property modelling application Property 3D cannot assemble a reservoir structural framework in the CMB that is of a moderate size and complexity due to an exhaustion of the 32-bit virtual memory. Typically, on the order of 50 to 100 faults, horizons and unconformities are involved in a framework assembly. Therefore, the exhaustion of the Property 3D virtual memory is not a result of the number of surfaces involved but a result of the solid modeller planar triangle surface shape representation. For example, knowing that one triangle uses 100 bytes of memory, that one {x, y, z} co-ordinate vertex needs 50 bytes and that the management of the triangles in a tree structure as defined by the solid modeller uses 50 bytes per triangle, if a surface is sampled at a density which is in the range of 300×200 to 1000×1000 points, then, for this density range, a typical surface buffer memory size is expected to be between 20 and 167 Mbytes. Thus, if Property 3D has to assemble a structural framework made up of 50 horizons and unconformities and 25 faults, where a 400×400 points sampling grid is imposed on each surface, then, each surface contains approximately 320000 triangles and requires a 53.4 Mbytes buffer memory size and the framework assembly finally requires 4.325 Gbyte of memory space. This is gigantic and more than twice the size of the user partition in a 32-bit virtual address space classically allowed by Property 3D in a 32-bit computer.

It has been contemplated to increase the 32-bit virtual memory. However, this solution is practically not satisfactory for business reasons.

### SUMMARY OF THE INVENTION

Considering the above state of the art, a technical problem that is intended to be solved by the invention is to represent, in one or a plurality of computer memories, a volume of earth that contains enough data points without proceeding to a simple increase of the virtual memory managed for such representation.

As a solution to the above problem, the invention relates to a method for representing a volume of earth using a modelling environment comprising an application, said environment being implemented in one or a plurality of programmed computers, characterised in that it comprises the following steps:

selecting said volume of earth;

inserting faults into said volume of earth in order to define at least one fault block;

inserting horizons and/or unconformities into said fault block in order to create at least a block unit; and

archiving said created block unit.

### DRAWINGS

The invention will be better understood in the light of the following detailed description of non-limiting and illustrative embodiments given with reference to the accompanying drawings, in which:

the FIG. 1A is a representation of a raw structural. framework before processing by an application Property 3D;

the FIG. 1B is an exploded view of a block unit after framework assembly using the application Property 3D;

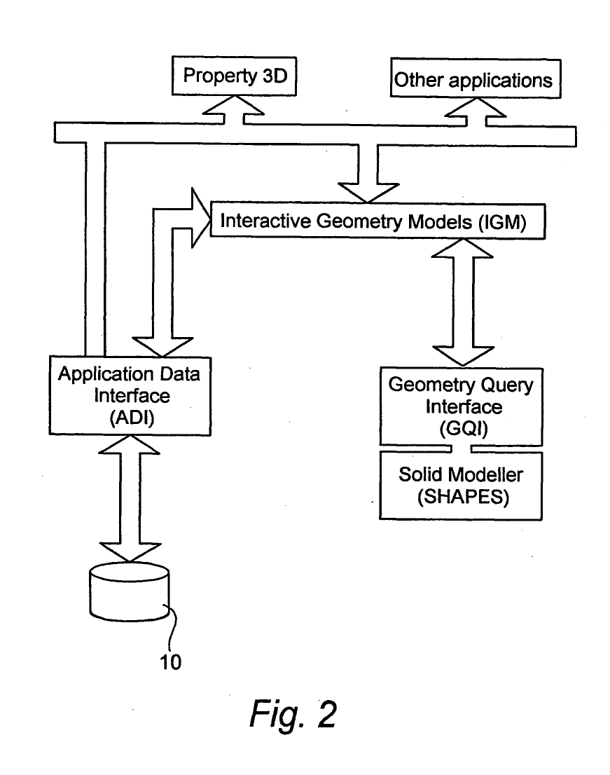

the FIG. 2 is a block diagram illustrating the modelling environment of the invention;

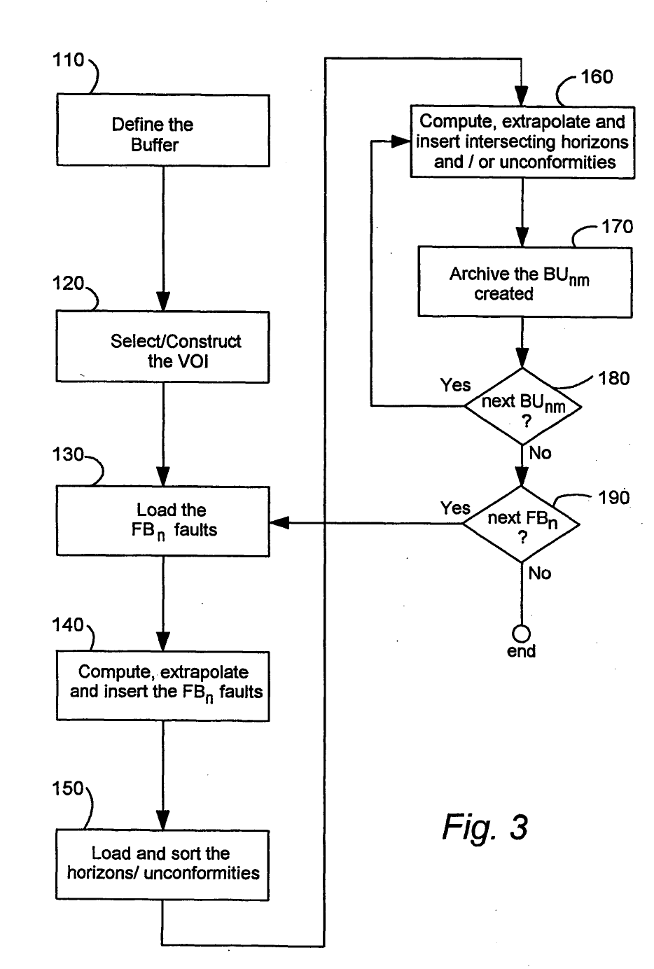

the FIG. 3 is a flow diagram illustrating the framework assembly implemented by the Property 3D application according to the invention; and

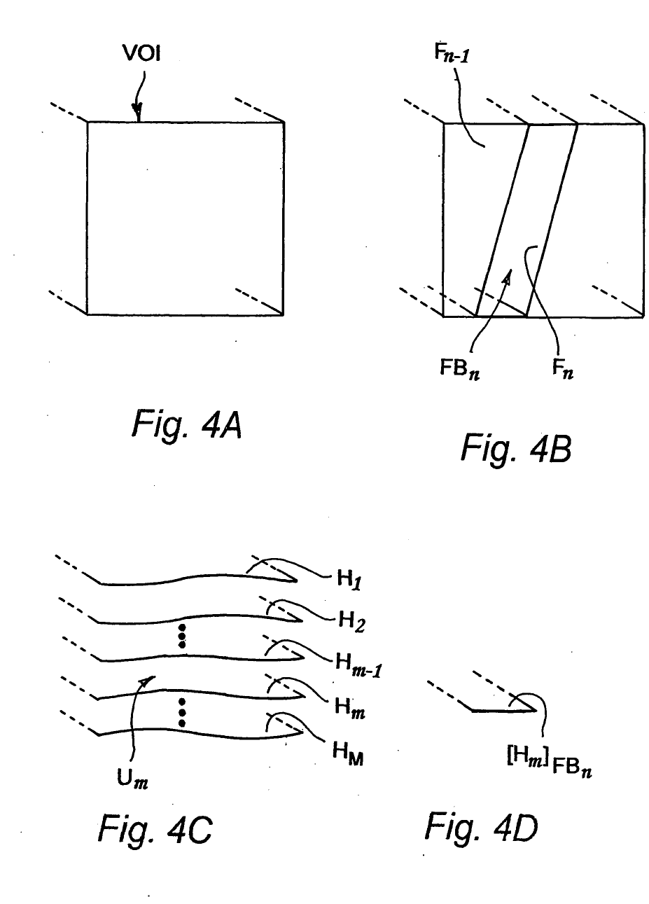

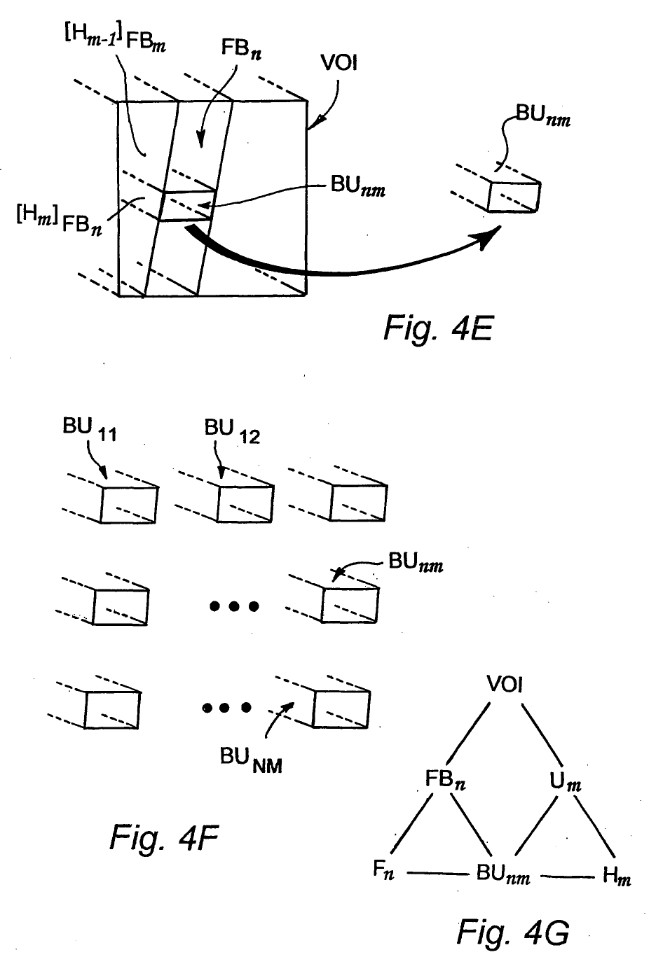

the FIGS. 4A, 4B, 4C, 4D, 4E, 4F and 4G schematise the various elements that are involved in a framework assembly according to the invention.

### DETAILED DESCRIPTION

The modelling environment of the invention is an integrated suite of software that permits the modelling of volumes of earth. As for the modelling environment of the state of the art, it comprises a CMB illustrated in the FIG. 2, which shows a three-level hierarchy. The bottom level comprises an ADI and a GQI associated with the SHAPES™ solid modeller provided by the XOX corporation, the middle level comprises an IGM and the top level comprises CMB applications such as the property modelling application Property 3D. The ADI provides a programmatic interface to a shareable database comprising bulk data corresponding to the volumes of earth to be modelled and further comprising, according to the invention, a directory containing geometry data structures of a discrete set of block units.

As for the bottom level of the modelling environment of the state of the art, the bottom level of the CMB allows access to the shareable database 10 and permits, on one hand, the construction of a geometric representation of a set of framework surfaces taken from differential geometry and combinatorial topology and, on the other hand, the three-dimensional visualisation of the geometric representation of said framework. In particular, the ADI manages the bulk data samples used to define the model and the solid modeller, which is the SHAPES™ modeller provided by the XOX corporation, is mainly a computational library for low dimensional combinatorial topology and differential geometry which takes a VOI as an empty box and represents surfaces of said VOI as connected sets of triangles without integrating any notion relating to geology or geophysics. The GQI generates and manipulates material property fields, hides data structure mismatches that may exist, for example a list of data structures in SHAPE™ that differs in GeoFrame, which is confusing to application developers, aggregates sets of the solid modeller primitive procedures into more readily usable services and implements the fundamental notion of a reservoir feature. It relies on the ADI for bulk data services for property fields that a CMB application manipulates.

The middle level provides high interactive geometrical model building, editing and rendering methods, as well as the middle level of the modelling environment of the state of the art. These services depend on the bottom level for their geometrical and topological content. However, communication with the bottom level is one way in the sense that the bottom level is not aware of the geological semantic which may be attached to the instances that are manipulated in the middle level or, above, in the top level.

In the invention, the top level also comprises geoscience and geometry based applications, which allow a user to create and update a three-dimensional representation of a VOI. Those applications invoke the GQI to assemble framework components into a topologically valid representation of the VOI and to attach various geologic fields to framework entities, thereby adding a geological semantic on top of the geometrical representation provided by the bottom level.

This is the case of Property 3D, which populates the framework that it assembles with property fields.

The solid modeller and the GQI are described in the patent granted under the number U.S. Pat. No. 6,128,577 entitled “Modeling Geological Structures and Properties” incorporated herewith by reference. It is noticed that, in the state of the art, the GQI navigates amongst the framework geological components, that is to say amongst the VOI, the fault blocks, the units and the block units, by querying the solid modeller regarding the topological relationships. For example, suppose that an application of the state of the art requests the set of block units that are bounded below a horizon. Then, the solid modeller represents the horizon and block units located below said horizon as geometrical cells and maintains the cell level connectivity information. The IGM rephrases for the solid modeller the geological question of how a horizon bounds a block unit into a geometrical-topological cell connectivity question. This correspondence is encoded, in the GQI, as a feature. Each fault, horizon, unconformity, fault block, unit or block unit is defined as a GQI feature. If a horizon bounds a block unit, then a 2D cell in the horizon's representation bounds a 3D cell in the block unit representation. If some cells of a sub-volume of the VOI are not loaded, then the solid modeller considers that the connectivity pertaining to this sub-volume does not exist. That is the reason why in order, for the IGM, to be able to navigate a framework without requiring the framework cells components to be loaded, the connectivity information is, according to the invention, recorded in the earth model instances, outside of the solid modeller representation.

Property 3D implements, in the CMB, a framework assembly according to the nine main following steps illustrated in the FIG. 3.

In a first step 110, the a buffer memory, in which the structural framework assembly will take place, is allocated. The size of the buffer memory is, for example, chosen so that the geometrical representation of the VOI, comprising a set of fault blocks and associated horizons and unconformities can be efficiently assembled and represented. A minimum memory space for assembly and representation of one complete fault block is required.

In a second step 120, the VOI is selected by the user of the Property 3D application and constructed in the buffer memory.

In a third step 130, the faults corresponding to a fault block FBₙ to be processed according to Property 3D workflow, are loaded into the application.

In a fourth step 140, the loaded faults are computed using the GQI, extrapolated and inserted into the VOI, thus defining a fault block FBₙ.

Then, in a fifth step 150, Property 3D loads the horizons and unconformities that are sorted by age.

Coherency is required for assigning a triangle to a surface cell. Therefore, before the sixth step hereunder, the application advantageously requests the solid modeller to insure that all of the bounding surfaces of an archival target are coherent, that is to say are such as the surface cell triangles intersect each other either at a vertex or along an edge.

In a sixth step 160, only the restricted part of each horizon and unconformity effectively intersecting the fault block FBₙ is computed using the GQI representation, extrapolated and inserted into said fault block FBₙ hence creating block units BUₙₘ.

In a seventh step 170, each block unit BUₙₘ, as it is created, is archived using the block unit archive algorithm described later in the present description. It is stored in a directory which is the same as the directory comprising the bulk data 10, but which is dedicated to the archival of geometry data.

In a eighth step 180, a test is executed in order to determine the next block unit BUₘ₊₁ to be processed. If a block unit BUₘ₊₁ effectively exists, then the sixth and seventh steps are repeated. In the negative, the application executes a ninth step hereunder.

According to said ninth step 190, a further test is executed in order to determine the next fault block FBₙ₊₁ to be processed. If a next fault block FBₙ₊₁ effectively exists, then the third to eighth steps are repeated. In the negative, it is the end of the framework assembly.

The FIGS. 4A to 4G schematise the various elements that are involved in the framework assembly of the invention. The FIG. 4A presents the VOI as a cube. In the FIG. 4B, two surfaces inserted in said cube constitute faults Fₙ₋₁ and Fₙ defining a fault block FBₙ. The FIG. 4C represents a set of horizons and/or unconformities H₁, H₂, . . . , Hₘ₋₁, Hₘ, . . . , H_{M} that are loaded and sorted in the application in connection with the VOI. The computed part of the horizon or unconformity Hm intersecting the fault block F_{B} is shown in the FIG. 4D where it is referenced [Hₘ]_{FBn}. The FIG. 4E illustrates the archival of the block unit BUₙₘ which is constituted after computation and insertion of the restricted horizons and/or unconformities [Hₘ₋₁]_{FBn} and [Hₘ]_{FBn}. A plurality of block units, instead of one, may be archived together according to the invention. The FIG. 4F illustrates the discrete set of block units BU₁₁, BU₁₂, . . . , BUₙₘ, . . . , BU_{NM} serially archived according to the method of the invention and the FIG. 4G illustrates the connectivity information recorded in relation to this set of block units.

As a result of the above steps, the VOI is, according to the invention, partitioned. Partition and block units archival are transparent with respect to the Property 3D workflow because this application accesses any earth model instance and, in particular, a block unit instance, using a look up procedure that automatically archives a block unit instance and shifts the connectivity knowledge from the geometry data structure to the earth entities that the geometry represents. Since the application accesses block units serially, one block unit needs to be in memory at any moment. In addition, the memory space required in the earth class definition is very limited, typically a few words. The original geometry data structure is gigantic, since it contains all the reservoir surfaces. The former expression of connectivity is small enough that it can be memory-resident at all time. The latter is prohibitively big. The IGM explicitly records surface and sub-volume connectivity information in its earth model instance definition. Therefore, an application is able to load explicitly all or some of any instances geometrical components.

The block unit archive algorithm used to archive block units in the IGM is as follows. In this algorithm, B denotes a block unit to be archived, C denotes the original reservoir representation of said block unit B in the aggregate, for example a fault block, containing it. F_{B} denotes one of the parent GQI features of the block unit B, F_{B}* denotes a new representation which parallels F_{B}, C* denotes a new representation which parallels C, and S is a surface cell, for example, one of the faults, horizons or unconformities that bounds B.

1. define a new framework representation C* whose geometric representation is B.

2. B has a plurality of parent features F_{B} in C, for example a unit and a fault block. Find all parent features {F_{B}} in C.

3. for each parent feature F_{B} in C, do the following:

construct a new feature F_{B}* of C* to represent B;

record F_{B} database handle in F_{B}*; and

record F_{B}* bounding box in F_{B}.

4. for each surface cell S that bounds B, execute the following steps:

find its parent feature Fₛ in C;

construct a new feature Fₛ* to hold S in C*;

add Fₛ* to C*;

record Fₛ database handle in Fₛ*;

for each surface cell in Fₛ*, record its bounding box in Fₛ; and

add S to Fₛ*.

5. extract B from C.

6. add B to F_{B}*.

7. if the structural framework entire cellular representation has been archived, then reset the pointer to C cell contents to a single nil cell.

8. invoke a command gqi_Save on C* which permits to save C* archive specification in the B CMB database identifier.

9. delete the property fields attached to B.

10. delete the memory instance B.

In this algorithm, the step 3 reproduces in C* a copy of every GQI-level feature containing the block unit B. Multiple block units topologically connected to each other are archived in one disk file. The step 4 enables feature-level property assignments added by the IGM itself to the surface to be maintained transparently. Any cell-level oriented material property on a surface is archived transparently also.

After having archived the block units archives in the database identifier, the application continues to locate said block units using said database identifier. The feature definitions in the block unit archive and in the parent representation deliberately share geometry identifiers, so the IGM is able to transfer cell pointers from the archived feature to its parent feature in the full reservoir representation. As concerns property fields, the IGM uses a parent feature database identifier in the archived representation. If a certain surface intersects a block unit in multiple cells, then the totality of the various parts is identified by their bounding box. When cell pointer transfer is complete, the IGM deletes from memory the remnants of the block unit archive.

According to the invention, the framework representation of a VOI is moved out of Property 3D, into the IGM. This necessitates the recording, in the IGM, of connectivity relations of the framework data structures that are independent of those managed by the solid modeller and duplicates, to some extent, information that is already contained in the solid modeller data structures. Practically, the IGM defines and records a volumetric structural framework as a collection of fault blocks, units and block units. Each fault block, unit and block unit record contains its fault, horizon and unconformities boundaries. Also, each block unit has a save and restore associated information that enables Property 3D to memory manage the framework and property fields attached to said block unit. Navigation within a block unit remains unchanged. However, navigation between various block units necessitates the use of topology information that the IGM encodes in each block unit data structure. The execution of geometrical queries require the intervention of the block unit low level solid modeller/GQI representation. For the restoration of a particular sub-volume designated by the application, the IGM restores all of the block units that form said sub-volume. It is noticed that restoration of a surface is qualified by orientation. Given the orientation, the IGM restores the relevant containers.

The IGM block unit representation contains the following memory management information that the IGM can access this information, independently of the status of the solid modeller block unit representation memory:—every structural framework feature whose cell-level definition intersects a block unit;—the list of correlation schemes, which correspond to the directives for grid generation, and the resulting grid;—all material property fields attached to a block unit, each property field knowing the grid that it references;—every property field aggregate that involves an attached property field; and—the size, in Mbytes, of an archived block unit, including scheme-induced grids and attached property fields.

Each horizon and fault that bounds a block unit records the block unit database archive handle and the bounding box of the intersection of the feature with the block unit. These fields are memory resident in the IGM parent reservoir representation.

Bounding box data is used to identify the set of surface cells that are contained in a block unit. The IGM defines the bounding box of the entire intersection of the surface in a block unit. The IGM cannot restore part rather than all of an archived block unit, so tracking the bounding box of each contained surface cell seems unnecessary.

It is therefore understood that the changes to the framework representation do not affect the Property 3D application material property field management notably because, in said application, property field creation and memory management services are distinct from the CMB property field services and, the correlation scheme, which is used in Property 3D population, is based on individual block units, so that the presence or absence of other block units is irrelevant. Therefore, as concerns the property population, each block unit of each unit is loaded and, for each block unit loaded, a 3D grid, based on the geometry of said block unit, is constructed and populated.

The Property 3D application can also say, as part of restoration, if the IGM should sew all the containers in memory together. Surface deformation is blocked unless the containers bounding both sides of a surface are loaded and sewn together.

### NUMERICAL EXAMPLE

Suppose that 50 horizons and 25 faults form a rectangular lattice inside a VOI. Then, said VOI decomposes into 25+1 =26 fault blocks, each fault block having two complete surfaces, at the top and the bottom, and four surface fragments, the remaining sides of the fault block. A fault block surface contains approximately 2×400×400=32000 triangles, which requires a buffer of size 53.4 Mbytes and each fault block surface fragment contains on average approximately. (2×400×400)/26=12308 triangles, which requires 2.05 Mbytes of memory. Therefore, each fault block needs approximately (2×53.4)+(4×2.05)=115 Mbytes of memory for its surface triangles. By restriction, a block unit bounding surfaces are made up of approximately (2×12308)+(2×6400)+(2×256)=37672 triangles, which requires 37672×175=6.44 Mbytes buffer. Comparing the size of the complete framework to the size of a single block unit, a reduction factor on the order of 4325/6.44=670:1 is achieved according to the invention.

Suppose that 1 Gbyte buffer memory space is allocated by Property 3D for framework assembly. Then partitioning the fault block set into five continuous sets of size {6, 5, 5, 5, 5} guarantees that each fault block set uses less than 6 ×115=690 Mbytes of memory and still allows approximately 310 Mbytes for surface representation.

When restricted to a fault block set, a horizon intersects the set in at most a 96×400 sampled region. This region contains approximately 76800 triangles and fits into a 12.82 Mbytes buffer. The partition the 50 input horizons is achieved into three contiguous groups of size {17, 17, 16}. Then, the solid modeller can intersect one horizon set with one fault block set in an approximately (17×12.82)+(6×115)=908 MByte buffer. All three horizon sets are intersected against each fault block set before going on to the next fault block set.

According to the invention, the CMB database contains a separate archive for each block unit. In addition, each fault, horizon and unconformity in the framework is duplicated. One copy of each surface is attached to the block unit on one side (the PLUS side) of said surface and the other copy is attached to the block unit on the other side (the MINUS side) of the surface. In the present example, 51×26=1326 block unit archives are generated, which requires 8.54 Gbyte of storage. When compared to the size of the original framework, the archive is about twice as large, as predicted. Property field archival is not taken into account, so a complete block unit archive will be much larger. The {6, 5, 5, 5, 5} fault block archives are temporary and disappear after the framework is assembled. Since the size of an individual block unit framework is relatively small, it is possible to concatenate a unit worth of block units in a single archive. In this case, 26 block units are combined, resulting in 51 unit archives. Each unit archive would need about 167 Mbytes of storage. A single precision scalar property field requires about 4×400×16 ×8=0.2 Mbytes of memory. In the IGM prototype enhancement, the grid space representation for this size block unit uses about 0.6 Mbytes. Therefore, if each single block unit has 6 single precision scalar property fields, it follows that its property field attachments require an additional 2.0 Mbytes. Combining the framework and property representation buffer requirements, each block unit needs about 8.5 Mbytes of memory. Therefore, each unit archive needs less than 350 Mbytes of storage.

It results of the above description and numerical example that according to the invention, Property 3D is able to assemble, in the CMB, a framework of an arbitrary complexity, that is to say a framework that contains an arbitrary number of unconformities, horizons and faults. Property 3D can invoke the method of the invention or not. Nevertheless, said mechanism does not change fundamentally the Property 3D workflow and remains invisible to the user of the application. There is no restriction relating to the surface sampling density and the sampling itself does not need to be uniform.

Finally, according to the invention, geometry and geology are clearly separated.

1. A method for representing a volume of earth using a modelling environment comprising an application, said environment being implemented in one or a plurality of programmed computers, characterised in that it comprises the following steps:
selecting said volume of earth;
inserting faults into said volume of earth in order to define at least one fault block;
inserting horizons and/or unconformities into said fault block in order to create at least a block unit;
archiving said created block unit; and
storing memory resident connectivity information related to the archived block.

2. A method according to claim 1, characterised in that it further comprises the step of:
defining a buffer memory for implementing the assembly.

3. A method according to claim 2, characterised in that the selected volume of earth is constructed in the buffer memory.

4. A method according to claim 1, characterised in that, prior to their insertion, the faults are loaded, computed using a geometry query interface of the modelling environment and extrapolated.

5. A method according to claim 1, characterised in that only the restricted part of each horizon and/or unconformity effectively intersecting the fault block is inserted into said fault block, after prior loading, computation using a geometry query interface of the modelling environment and extrapolation.

6. A method according to claim 1, characterised in that the block unit archived is stored in a directory dedicated to the archival of geometry data structures.

7. A method according to claim 1, characterised in that a test is executed in order to determine the next block unit to be processed.

8. A method according to claim 1, characterised in that a test is executed in order to determine the next fault block to be processed.

9. A method according to claim 1, characterised in that it further comprises the step of:
restoration of the archived block units.

10. A method according to claim 1, further comprising the step of:
populating the archived block units with material property fields.

11. A method according to claim 1, characterised in connectivity information relating to the archived block units is stored separately from geometry data structures of said block units.

12. A method according to claim 11, characterised in that the connectivity information is memory resident in the modelling environment.

13. A method according to claim 1, characterised in that an interface geometry modeller manages connectivity information relating the archived block units.
